(19) United States
(12) Patent Application Publication
(10) Pub. No.: US 2025/0224278 A1
(43) Pub. Date: Jul. 10, 2025

(54) TEMPERATURE SENSOR ASSEMBLY

(71) Applicant: HarcoSemco LLC, Branford, CT (US)

(72) Inventors: Thomas Bieluch, Stamford, CT (US); Robert Croce, Guilford, CT (US)

(21) Appl. No.: 19/016,517

(22) Filed: Jan. 10, 2025

Related U.S. Application Data
(60) Provisional application No. 63/619,693, filed on Jan. 10, 2024.

(51) Int. Cl. G01K 1/16; G01K 1/08; G01K 7/16

(52) U.S. Cl. CPC G01K 1/16; G01K 1/08; G01K 7/16

(57) ABSTRACT

Provided is a sensor assembly including a body, and a probe assembly configured to be coupled to the body, the probe assembly including a probe housing, one or more sensing elements disposed in the probe housing, and a rod at least partially disposed in the probe housing between the one or more sensing elements and the body, wherein the rod is formed of a low thermal conductivity material.

### RELATED APPLICATIONS

This application claims the benefit of U.S. Provisional Application No. 63/619,693 filed Jan. 10, 2024, which is hereby incorporated herein by reference.

### FIELD OF INVENTION

The present invention relates generally to temperature sensing, and more particularly to a thermal conduction insensitive temperature sensor assembly.

### BACKGROUND

In an environmental control system, a temperature sensor assembly may be installed in an air duct where a portion of the assembly is under dynamic airflow and exposed to temperatures that are significantly above or below the ambient environment where another portion of the assembly is installed.

### SUMMARY OF INVENTION

According to an aspect, a sensor assembly is provided that includes a body and a probe assembly configured to be coupled to the body, the probe assembly including a probe housing, one or more sensing elements disposed in the probe housing, and a rod at least partially disposed in the probe housing between the one or more sensing elements and the body, wherein the rod is formed of a low thermal conductivity material.

According to another aspect, a sensor assembly is provided that includes a body, a probe assembly configured to be coupled to the body, the probe assembly including a probe housing, a plurality of sensing elements disposed in the probe housing, and a rod at least partially disposed in the probe housing between the plurality of sensing elements and the body, and a high thermal conductivity potting around the plurality of sensing elements, wherein the rod is formed of a low thermal conductivity material.

According to still another aspect, a sensor assembly is provided that includes a body, a probe assembly configured to be coupled to the body, the probe assembly including a probe housing, a plurality of sensing elements disposed in the probe housing, and a rod at least partially disposed in the probe housing between the plurality of sensing elements and the body, and a high thermal conductivity potting around the plurality of sensing elements, wherein the rod is formed of a low thermal conductivity material, and wherein the probe housing is coupled to the body or wherein the rod is coupled to the body.

The foregoing and other features of the application are described below with reference to the drawings.

### BRIEF DESCRIPTION OF THE DRAWINGS

FIG. 1 is a perspective view of an exemplary sensor assembly.

FIG. 2 is another perspective view of the sensor assembly.

FIG. 3 is still another perspective view of the sensor assembly.

FIG. 4 is a side view of the sensor assembly.

FIG. 5 is a front view of the sensor assembly.

FIG. 6 is a rear view of the sensor assembly.

FIG. 7 is a cross-sectional view of the sensor assembly.

FIG. 8 is a perspective view of the sensor assembly without a sensor housing and rod.

FIG. 9 is a perspective view of the sensor assembly without the sensor housing.

FIG. 10 is a perspective view of another exemplary sensor assembly.

FIG. 11 is another perspective view of the sensor assembly.

FIG. 12 is still another perspective view of the sensor assembly.

FIG. 13 is a side view of the sensor assembly.

FIG. 14 is a front view of the sensor assembly.

FIG. 15 is a rear view of the sensor assembly.

FIG. 16 is a cross-sectional view of the sensor assembly.

FIG. 17 is a perspective view of the sensor assembly without a sensor housing and rod.

### DETAILED DESCRIPTION

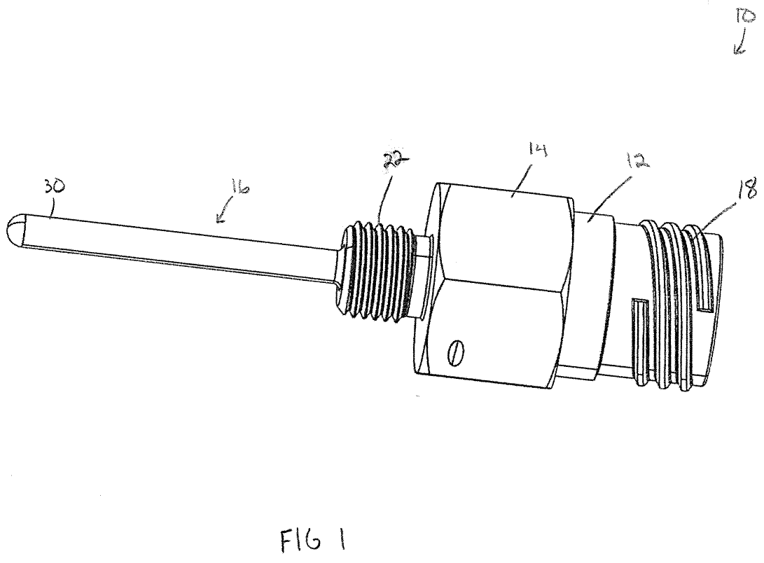

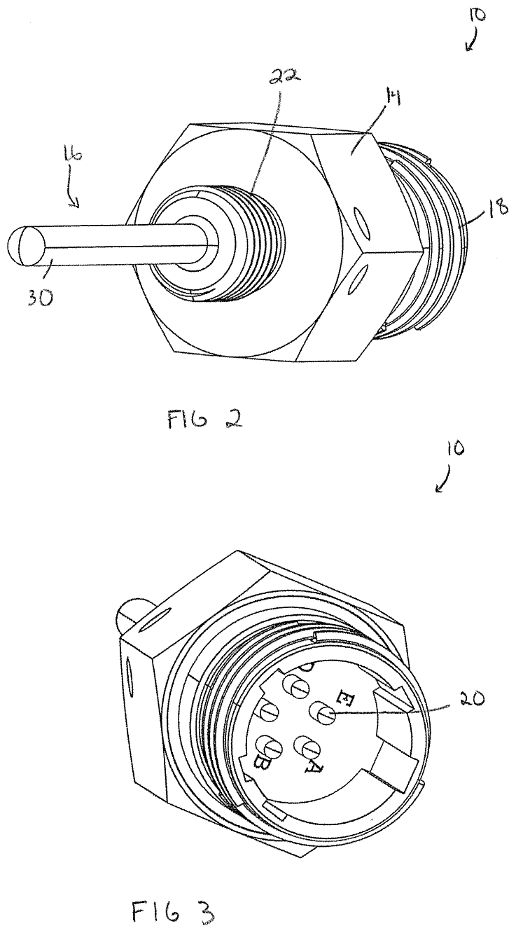

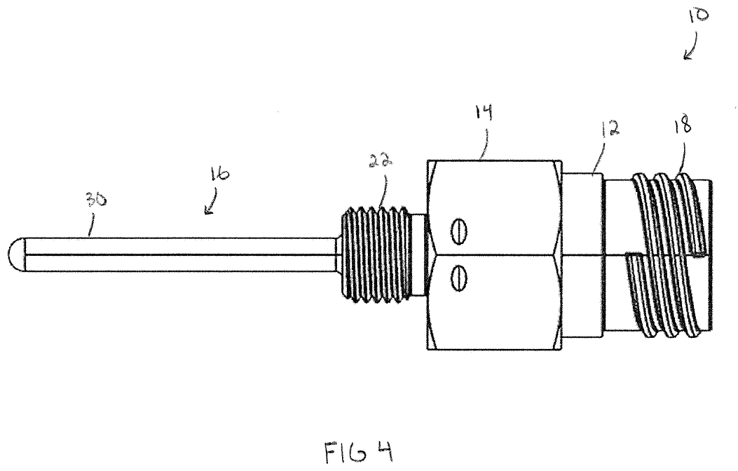

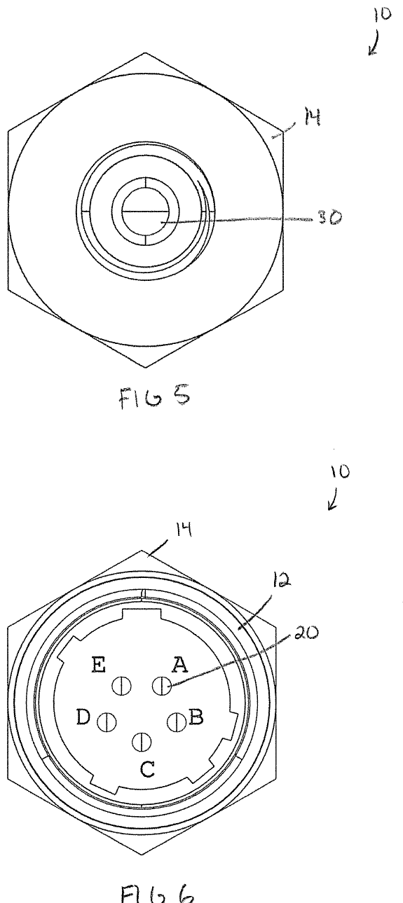

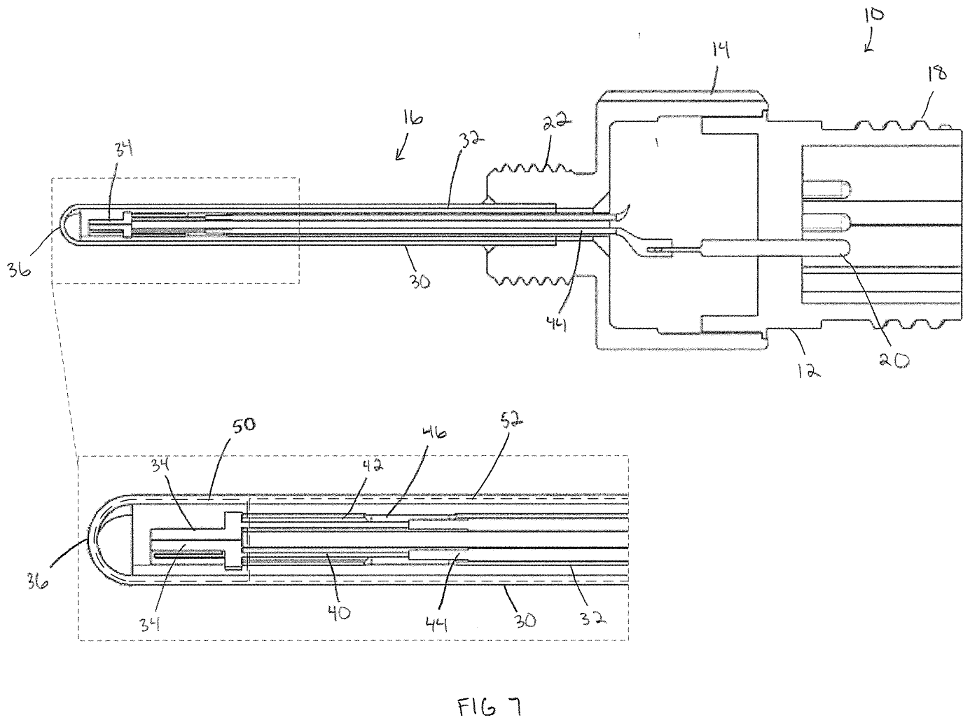

Turning initially to FIGS. 1-6, a temperature sensor assembly is shown generally at reference numeral 10. The sensor assembly includes a body having a housing 12 and a boss 14 configured to be coupled to the housing 12, and a probe assembly 16 coupled to the boss 14. The housing 12 and boss 14 may be made of a suitable material, such as metal, such as stainless steel. The housing 12 may be coupled to a harness, for example, in a suitable manner, such as by a threaded connection 18, and may include a plurality of pins 20 configured to be coupled to wires of the probe assembly 16 as will be described below. The boss 14 may be coupled to a duct, for example, such as an aircraft duct, in a suitable manner, such as by a threaded connection 22 or a mounting flange.

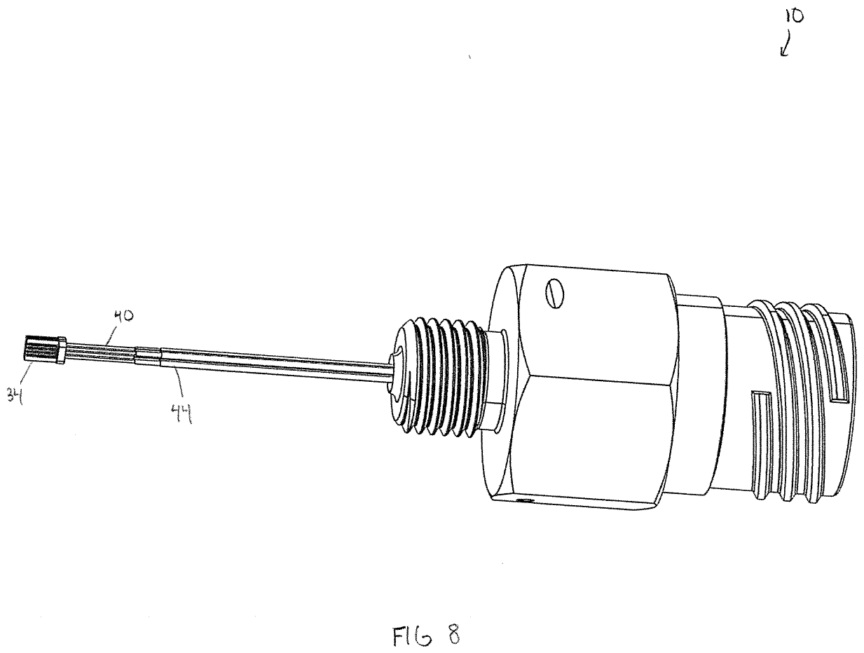

Turning additionally to FIGS. 7-9, the probe assembly 16 includes a probe housing 30 or sheath coupled to the boss 14, a rod 32 disposed in the probe housing 30, and one or more sensing elements 34 disposed in the probe housing 30. The probe assembly 16 is designed to be positioned in the duct, with the one or more sensing elements 34 being designed to be positioned near or in the center of the duct. The rod 32 is positioned between the one or more sensing elements 34 and the housing 12 and boss 14 to insulate the one or more sensing elements 34 from thermal conduction between a tip 36 of the probe housing 30 and the housing 12 and boss 14. The probe housing 30 may be made of a suitable material, such as metal, such as stainless steel, and may be coupled to the boss 14 in a suitable manner, such as by brazing. The rod 32 may be a suitable low thermal conductivity material, such as a ceramic rod, such as a mullite or zirconia ceramic rod to insulate the one or more sensing elements 34 and to minimize or eliminate thermal conduction through the rod 32 that would otherwise reduce accuracy of the one or more sensing elements 34.

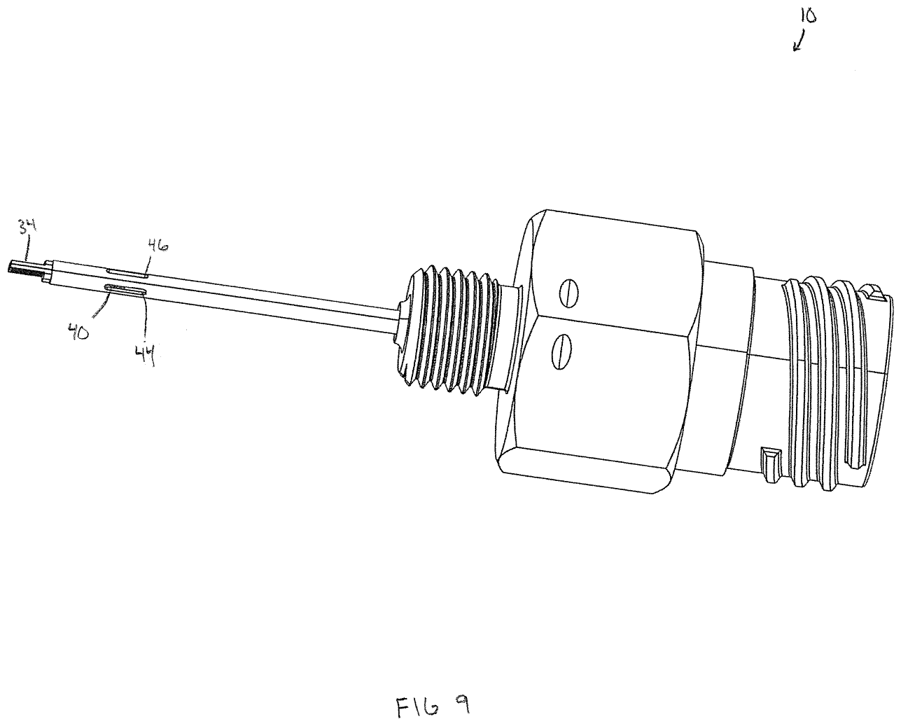

The one or more sensing elements 34, and as shown two sensing elements 34, may be thin film elements, such as one or more resistance temperature detector (RTD) sensing elements, such as two RTD sensing elements 34. The sensing elements 34 each have one or more wires 40 extending therefrom, and as shown in FIG. 8 with the probe housing 30 and the rod 32 removed, two wires 40 each that extend into respective bores 42 in the rod 32. The bores 42 serve to center the wires 40 and isolate the wires 40 from the walls of the assembly. The wires 40 extend through the respective bores 42 to couple directly to a respective one of the pins 20 or connectors, or may be coupled to respective extension lead wires 44 within the bores 42 as shown, for example by brazing, and the lead wires 44 are coupled to the respective pins 20 or connectors. As shown in FIG. 9 where the probe housing 30 is removed, to allow for the connection of the wires 40 to the lead wires 44, the rod 32 includes one or more windows 46, and as shown four windows 46 circumferentially spaced around the rod 32, one for each bore 42, extending from an outside surface of the rod 32 into a respective one of the bores 42 to allow for the wires 40 to be coupled to the respective wires 44. It will be appreciated that the sensing elements 34 may have any suitable number of wires 40 and the assembly may have a corresponding number of lead wires 44 and windows 46 to the wires 40.

The sensing elements 34 may be held in position and be hermetically sealed in the probe housing 30 in a suitable manner, such as by a high conductivity potting, such as boron nitride, around the sensing elements 34 as shown by dashed line 50 in FIG. 7. The high conductivity potting 50 provides for heat transfer between the tip 36 and the surrounding fluid media around the sensing elements 34 and provides for the sensing elements 34 to rapidly respond to temperatures in the surrounding fluid media. A low conductivity potting, such as magnesium oxide, is provided to fill voids between the probe housing 30 and the rod 32 providing strain relief and structural support as shown by dashed line 52 in FIG. 7. The low thermal conductivity potting 52 is provided between the high thermal conductivity potting 50 and the body in voids between the rod 32 and the probe housing 30. For example, the low thermal conductivity potting 52 extends from a point near a base of the sensing elements 34 around the rod 32, including around the windows 46, to the body. In an implementation, to make the sensor assembly 10, a controlled volume of the high thermal conductivity potting 50 is injected in the probe housing 30 at the tip 36 and then the sensing elements 34 and rod 32 are inserted into the probe housing 30. The low thermal conductivity potting 52 is then filled in the probe housing 30 around the rod 32 in a suitable manner, such as by backfilling to localize the high conductivity potting 50.

Aerospace temperature sensors are specified to have accuracy tolerance bands under all operating conditions. In an example, in an environmental control system, the temperature sensor is installed in an air duct where a housing coupled to the sensor is under dynamic airflow and exposed to temperatures that are significantly above or below the ambient environment where the temperature sensor is installed. This difference creates an unpredictable temperature gradient across the temperature sensor. If the temperature gradient is large enough, and the airspeed in the duct is insufficient to provide adequate convective heat transfer across the entire exposed surfaces of the temperature sensor, the temperature gradient will draw heat away from the sensing tip to the ambient environment thus reducing sensor accuracy and causing thermal conduction error.

The sensor assembly 10 is provided to minimize or eliminate the thermal conduction error by hindering internal sensor thermal conduction from the tip 36 to the boss 14 to preserve accuracy at all airflow and installations configurations. With the sensor assembly 10, the sensing elements 34 can track to the temperature in the temperature controlled environment in the duct with minimal or no influence from temperatures outside the duct. The sensor assembly 10 can also be used to reduce thermal conduction error in thermal dispersion-type flow sensors that output airflow and temperature data based on the resistance of sensing elements in the airstream. Reduction of thermal conductivity and associated error on the heated and un-heated probes will minimize airflow flow and thermal hysteresis measurements by rendering the sensing elements stable across all ambient temperature conditions.

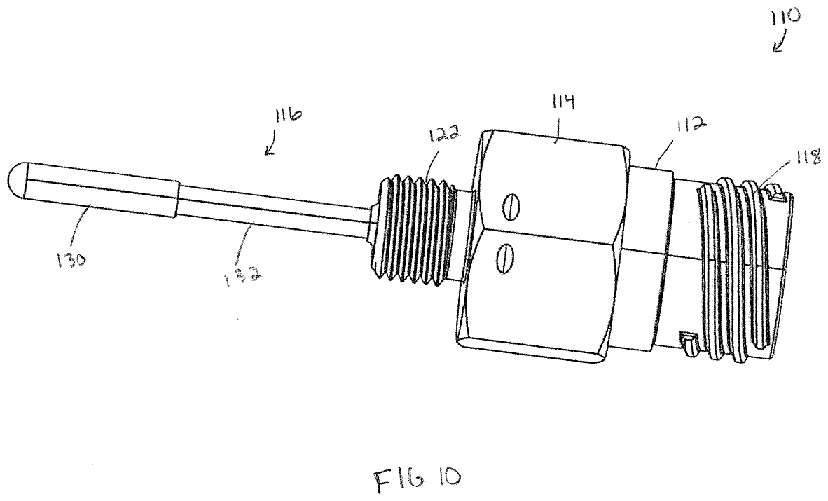

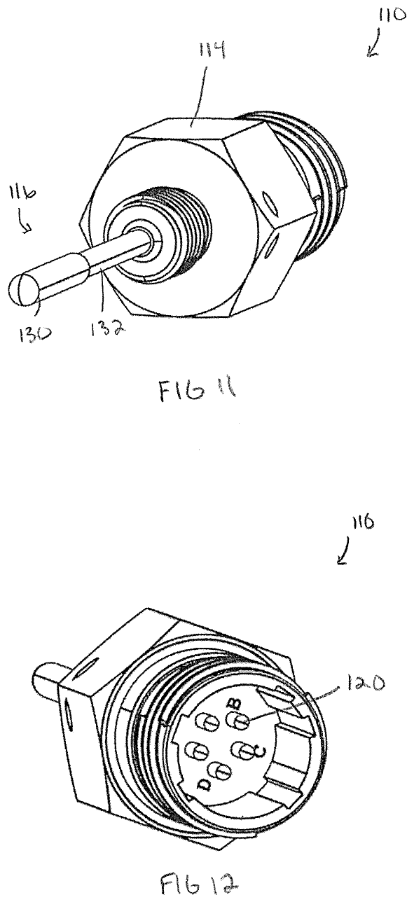

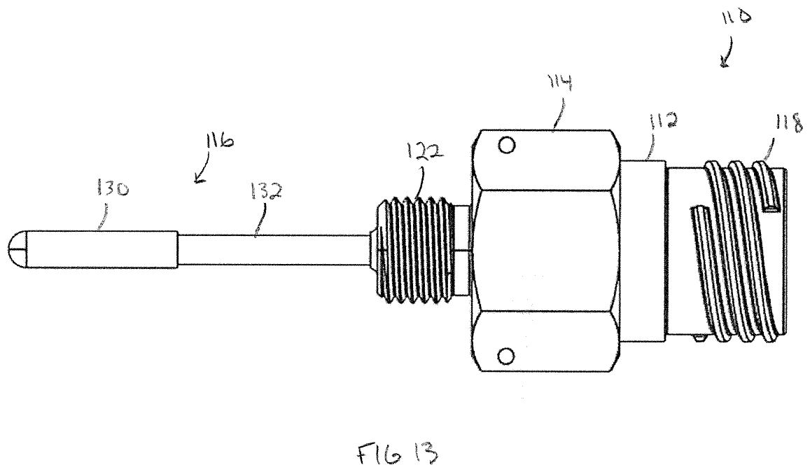

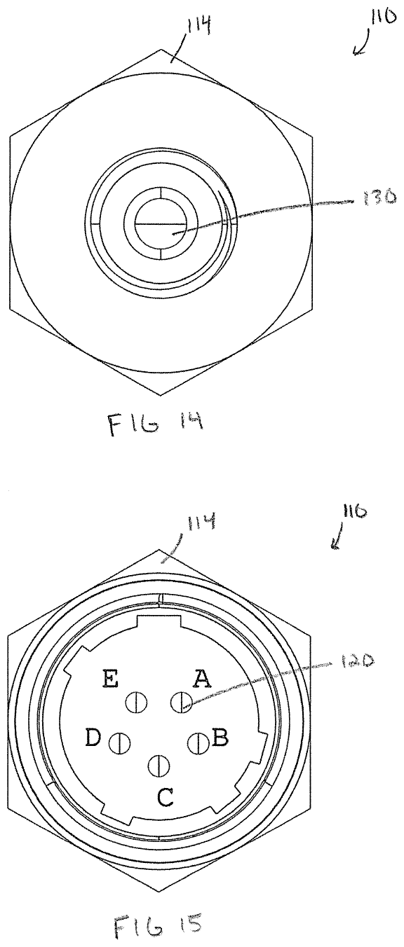

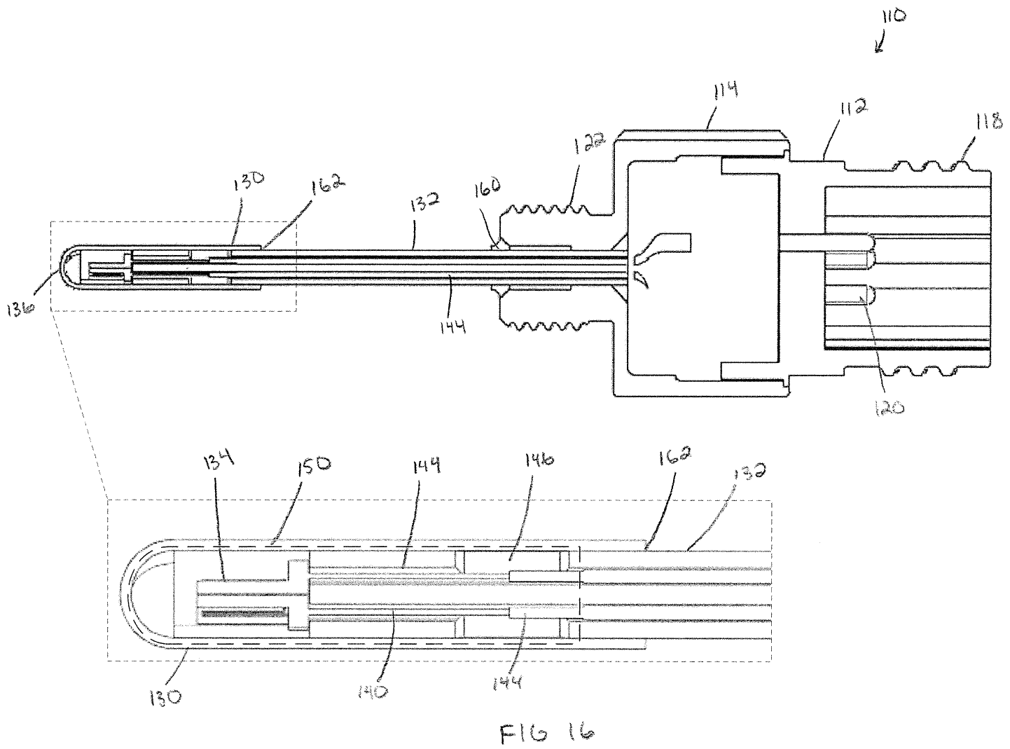

Turning now to FIGS. 10-17, an exemplary embodiment of the sensory assembly is shown at 110. The sensor assembly 110 is substantially the same as the above-referenced sensor assembly 10, and consequently the same reference numerals but indexed by 100 are used to denote structures corresponding to similar structures in the sensor assemblies. In addition, the foregoing description of the sensor assembly 10 is equally applicable to the sensor assembly 110 except as noted below.

The sensor assembly 110 includes a body having a housing 112 and a boss 114 configured to be coupled to the housing 112, and a probe assembly 116 coupled to the boss 114. The housing 112 and boss 114 may be made of a suitable material, such as metal, such as stainless steel. The housing 112 may be coupled to a harness, for example, in a suitable manner, such as by a threaded connection 118, and may include a plurality of pins 120 configured to be coupled to wires of the probe assembly 116 as will be described below. The boss 114 may be coupled to a duct, for example, such as an aircraft duct, in a suitable manner, such as by a threaded connection 122 or a mounting flange.

The probe assembly 116 includes a probe housing 130 or sheath, a rod 132 partially disposed in the probe housing 130 and coupled to the boss 114 and the probe housing 130, and one or more sensing elements 134 disposed in the probe housing 130. As shown, a first portion of the rod 132 is covered by the probe housing 130 and a second portion of the rod 132 is exposed to environment in the duct. In an implementation, the probe housing 130 may cover less than half a length of the rod 132. The rod 132 is positioned between the one or more sensing elements 134 and the boss 114 and housing 112 to insulate the one or more sensing elements 134 from thermal conduction between a tip 136 of the probe housing 130 and the boss 114 and housing 112. The probe housing 130 may be made of a suitable material, such as metal, such as stainless steel. The rod 132 may be a suitable low thermal conductivity material, such as a ceramic rod, such as a mullite or zirconia ceramic rod to insulate the sensing elements 134 and minimize or eliminate thermal conduction through the rod 132 that would otherwise reduce accuracy of the sensing elements 134. The rod 132 may be coupled to the boss 114 and the probe housing in a suitable manner, such as by brazing or epoxy. For example, the rod 132 may be coupled to the boss 114 by brazing or epoxy at a location identified by reference numeral 160 and coupled to the probe housing 130 by brazing or epoxy at a location identified by reference numeral 162. In an implementation using brazing, the rod 132 may be metallized at locations 160 and 162.

The one or more sensing elements 134, and as shown two sensing elements 134, may be thin film elements, such as one or more resistance temperature detector (RTD) sensing elements, such as two RTD sensing elements 134. The sensing elements 134 each have one or more wires 140 extending therefrom, and as shown in FIG. 17 with the probe housing 130 and the rod 132 removed, two wires 140 each that extend into respective bores 142 in the rod 132. The wires 140 extend through the respective bores 142 to couple directly to a respective one of the pins 120 or connectors, or may be coupled to respective extension lead wires 144 within the bores 142 as shown, for example by brazing, and the lead wires 144 are coupled to the respective pins 120 or connectors. The rod 132 includes one or more windows 146, and as shown four windows 146 circumferentially spaced around the rod 132, one for each bore 142, extending from an outside surface of the rod 132 into a respective one of the bores 142 to allow for the wires 140 to be coupled to the lead wires 144.

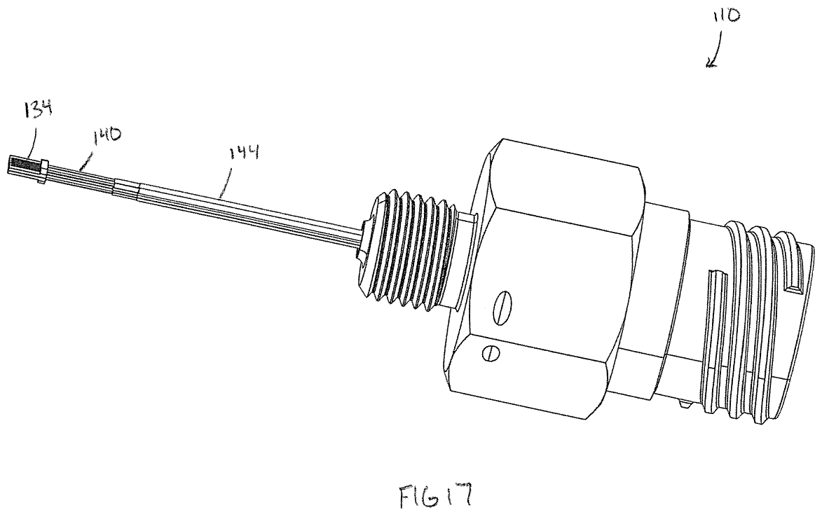

The sensing elements 134 may be hermetically sealed in the probe housing 130 in a suitable manner, such as by a high conductivity potting, such as boron nitride, shown by dashed line 150 in FIG. 16. For example, the high thermal conductivity potting extends from the tip 136 toward the open end of the probe housing 132, including around the windows 146. The high conductivity potting 150 provides for heat transfer between the tip 136 and the surrounding fluid media around the sensing elements 134 and provides for the sensing elements 134 to rapidly respond to temperatures in the surrounding fluid media. In an implementation, to make the sensor assembly 110, a controlled volume of the high thermal conductivity potting 150 is injected in the probe housing 130 at the tip 136 and then the sensing elements 134 and rod 132 are inserted into the probe housing 130.

Although certain embodiments have been shown and described, it is understood that equivalents and modifications falling within the scope of the appended claims will occur to others who are skilled in the art upon the reading and understanding of this specification.

What is claimed is:

1. A sensor assembly comprising:
a body; and
a probe assembly configured to be coupled to the body, the probe assembly including a probe housing, one or more sensing elements disposed in the probe housing, and a rod at least partially disposed in the probe housing between the one or more sensing elements and the body,
wherein the rod is formed of a low thermal conductivity material.

2. The sensor assembly according to claim 1, wherein the probe housing is coupled to the body.

3. The sensor assembly according to claim 2, further including a high thermal conductivity potting around the one or more sensing elements and a low thermal conductivity potting between the high thermal conductivity potting and the body in voids between the rod and the probe housing.

4. The sensor assembly according to claim 1, wherein the rod is coupled to the body and the probe housing.

5. The sensor assembly according to claim 4, wherein a first portion of the rod is covered by the probe housing and a second portion of the rod is exposed.

6. The sensor assembly according to claim 5, further including a high thermal conductivity potting around the one or more sensing elements.

7. The sensor assembly according to claim 1, wherein the one or more sensing elements include a plurality of sensing elements, in particular thin film elements, in particular resistance temperature detector (RTD) sensing elements.

8. The sensor assembly according to claim 7, wherein the rod includes a plurality of bores extending along its length, and wherein each of the plurality of sensing elements includes one or more wires extending therefrom that extend into a respective one of the bores in the rod.

9. The sensor assembly according to claim 8, further including a plurality of lead wires, each lead wire extending through a respective one of the plurality of bores and being coupled to a respective one of the wires of the sensing elements.

10. The sensor assembly according to claim 9, wherein the rod includes a window for each of the bores extending from an outer surface of the rod to the bore for coupling the wires of the sensing elements to the respective lead wires.

11. The sensor assembly according to claim 1, wherein the body and the probe housing are formed of stainless steel.

12. The sensor assembly according to claim 1, wherein the rod is formed of a low thermal conductivity ceramic.

13. A sensor assembly comprising:
a body;
a probe assembly configured to be coupled to the body, the probe assembly including a probe housing, a plurality of sensing elements disposed in the probe housing, and a rod at least partially disposed in the probe housing between the plurality of sensing elements and the body; and
a high thermal conductivity potting around the plurality of sensing elements,
wherein the rod is formed of a low thermal conductivity material.

14. The sensor assembly according to claim 13, wherein the probe housing is coupled to the body and wherein a low thermal conductivity potting is provided between the high thermal conductivity potting and the body in voids between the rod and the probe housing.

15. The sensor assembly according to claim 13, wherein the rod is coupled to the body and the probe housing.

16. The sensor assembly according to claim 15, wherein a first portion of the rod is covered by the probe housing and a second portion of the rod is exposed.

17. The sensor assembly according to claim 13, wherein the rod includes a plurality of bores extending along its length, and wherein each of the plurality of sensing elements includes one or more wires extending therefrom that extend into a respective one of the bores in the rod.

18. The sensor assembly according to claim 17, further including a plurality of lead wires, each lead wire extending through a respective one of the plurality of bores and being coupled to a respective one of the wires of the sensing elements.

19. The sensor assembly according to claim 18, wherein the rod includes a window for each of the bores extending from an outer surface of the rod to the bore for coupling the wires of the sensing elements to the respective lead wires.

20. A sensor assembly comprising:
a body;
a probe assembly configured to be coupled to the body, the probe assembly including a probe housing, a plurality of sensing elements disposed in the probe housing, and a rod at least partially disposed in the probe housing between the plurality of sensing elements and the body; and
a high thermal conductivity potting around the plurality of sensing elements,
wherein the rod is formed of a low thermal conductivity material, and
wherein the probe housing is coupled to the body or wherein the rod is coupled to the body.
